(19) United States
(12) Patent Application Publication
(10) Pub. No.: US 2005/0205483 A1
(43) Pub. Date: Sep. 22, 2005

(54) Microimpactor system for collection of particles from a fluid stream

(76) Inventors: Joseph Gerard Birmingham, Lake Oswego, OR (US); Daniel James Faulkner, Portland, OR (US); Alireza Shekarniz, Lake Oswego, OR (US)

Correspondence Address: GARY C. COHN, PLLC, 1147 NORTH FOURTH STREET, UNIT 6E, PHILADELPHIA, PA, 19123, US

(21) Appl. No.: 10/805,869

(22) Filed: Mar. 22, 2004

(51) Int. Cl. B01D 35/00

(52) U.S. Cl. 210/322

(57) ABSTRACT

A microimpactor device for separating particles from a fluid stream includes a plurality of microimpactor sheets. The microimpactor sheets include a series of openings that define one or more rows of microimpactor surfaces. Multiple rows of microimpactors are provided by including a corresponding number of microimpactor sheets within the device.

### BACKGROUND OF THE INVENTION

This invention relates to apparatus and methods for separating particulate matter (solid particles and/or liquid droplets) from a fluid stream.

It is often desirable to remove particulate matter from a fluid stream. For example, it may be desired to simply cleanse the fluid of the particulate matter, or at least reduce the concentration of the particulate matter in the stream. In other instances, the goal is to capture a certain size range of particulate matter for analysis and/or characterization. Sometimes, the aim is to simply concentrate the particulate matter so that it can be used in some way.

A large number of devices exist for this purpose. These include various types of filters, cyclones, electrostatic precipitators, among other devices. For removing very small particulate matter, such as aerosol particles and microorganisms, from a gas stream, various types of virtual cyclones and virtual impactor devices have been devised. Examples of these are described in U.S. Pat. Nos. 6,156,212 and 6,386,015 (micromachined virtual impactor), U.S. Pat. No. 6,432,630 (micro-flow system using an external field to deflect particles), U.S. Pat. No. 6,270,558, U.S. Pat. No. 6,465,225 (centrifugal- or gravity-fed deflection system); U.S. Pat. No. 6,467,630 (column with applied “convective force”); and U.S. Pat. No. 6,062,392 (virtual impactor).

In many applications, it is necessary to perform the separation of particulate matter using small, lightweight apparatus that operates simply and requires minimal energy. In many devices, an efficient separation can be performed only if there is a high pressure drop through the device, or if some other energy (such as to create an external, particle-deflecting field) is applied. To address this problem, U.S. Pat. No. 6,110,247 describes a micropillar device which relies on an array of micropillar rows to capture particles from a fluid stream. The micropillar device provides separation of particulate matter at moderate pressure drops, while still allowing for recovery of the captured particulate matter. The micropillar device described in U.S. Pat. No. 6,110,247 is made in a micromachining process, and so is expensive to manufacture. Further, the micromachining process fixes the size and spacing of the individual micropillars as well as the relative positions of the micropillar rows. As these factors bear heavily on the separation efficiency, in many cases such fixed micropillar structures are limited in the range of applications or conditions for which they are suitable. Each structure is designed and optimized for a particular application, and operates inefficiently (if at all) when the conditions of use change or if put into a different application. The micromachined micropillars cannot be adapted easily for multiple uses. Therefore, a less expensive, more versatile separation device that can operate under a low pressure drop is desired.

### SUMMARY OF THE INVENTION

In one aspect, this invention is a microimpactor system comprising a fluid conduit having a plurality of rows of microimpactors arranged in the fluid conduit substantially transverse to a main direction of flow of fluid through the fluid conduit, wherein each of said rows of microimpactors is formed by a microimpactor sheet having a plurality of openings that define in each such sheet at least one line of two or more microimpactors.

In a second aspect, this invention is a method of forming an array of microimpactor surfaces within a fluid conduit, comprising positioning two or more microimpactor sheets each having openings that define in each microimpactor sheet at least one line of two or more microimpactors, the microimpactor sheets being positioned such that said microimpactors are oriented transverse to a main direction of flow of a fluid through the fluid conduit.

The microimpactor system of the invention offers several advantages. Because the microimpactor system consists of a series of sheets, it can be manufactured using various production methods that are less expensive and more versatile than the micromachining methods required to produce micropillar systems as described in U.S. Pat. No. 6,110,247. As described more below, the sheets are conveniently prepared using chemical etching processes as are commonly used in other applications; individual sheets are then assembled to form the final microimpactor system.

The microimpactor system of this invention can be more readily tailored to specific applications and/or specific operational conditions, because the microimpactor system includes a series of individual microimpactor sheets which can be separately fabricated. Various aspects of the flow path through the microimpactor system can be modified to optimize the microimpactor system to specific applications and conditions, through the selection and/or placement of specific microimpactor sheets and/or by adjusting the spacing between successive sheets, as explained in more detail below.

This microimpactor system is often easier to clean or otherwise extract captured particles. The microimpactor system can be made to be disassembled easily to recover the individual microimpactor sheets with their captured particles, for cleaning, particle recovery or analysis.

Individual microimpactor sheets in the system can be made of wide range of materials, including materials that cannot be micromachined readily. The ability to use more and different materials permits more flexibility in design, and permits specific functionalities to be incorporated into the system that are not conveniently added into a micromachine micropillar system. Different microimpactor sheets can even be made or coated with different materials, which creates even greater design flexibility and diversity in function.

### BRIEF DESCRIPTION OF THE DRAWINGS

FIG. 1 is a view of a microimpactor system according to the invention.

FIG. 2 is a top view of a microimpactor sheet according to the invention.

FIG. 3 is an exploded view of the microimpactor system of FIG. 1.

FIG. 4 is an exploded view of a second embodiment of a microimpactor system of the invention.

### DETAILED DESCRIPTION OF THE INVENTION

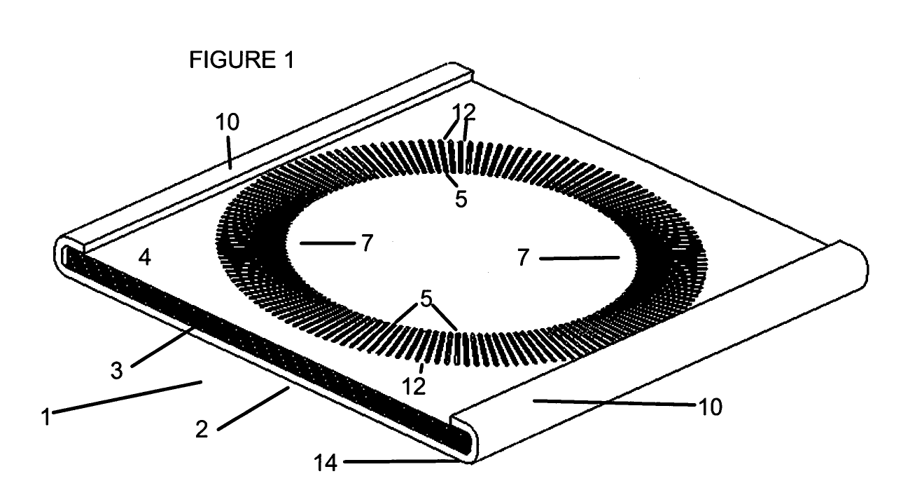

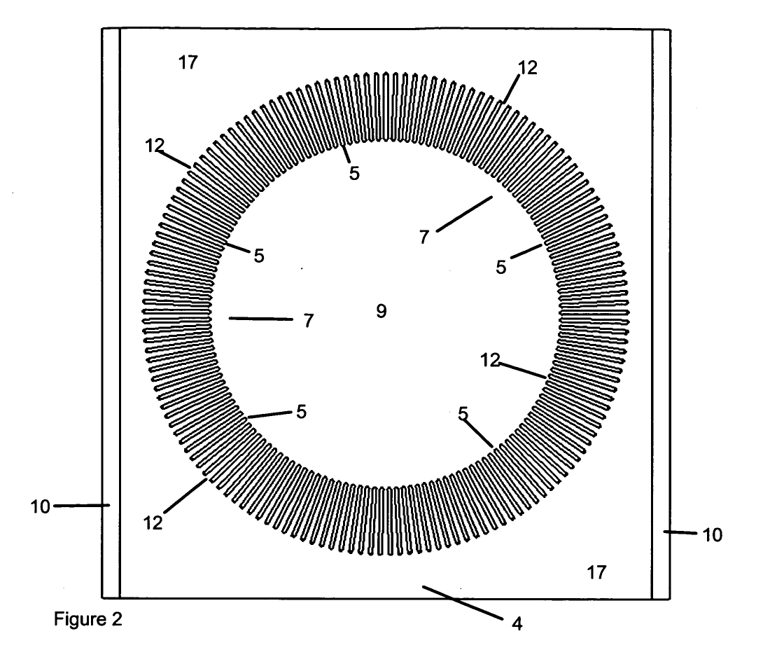

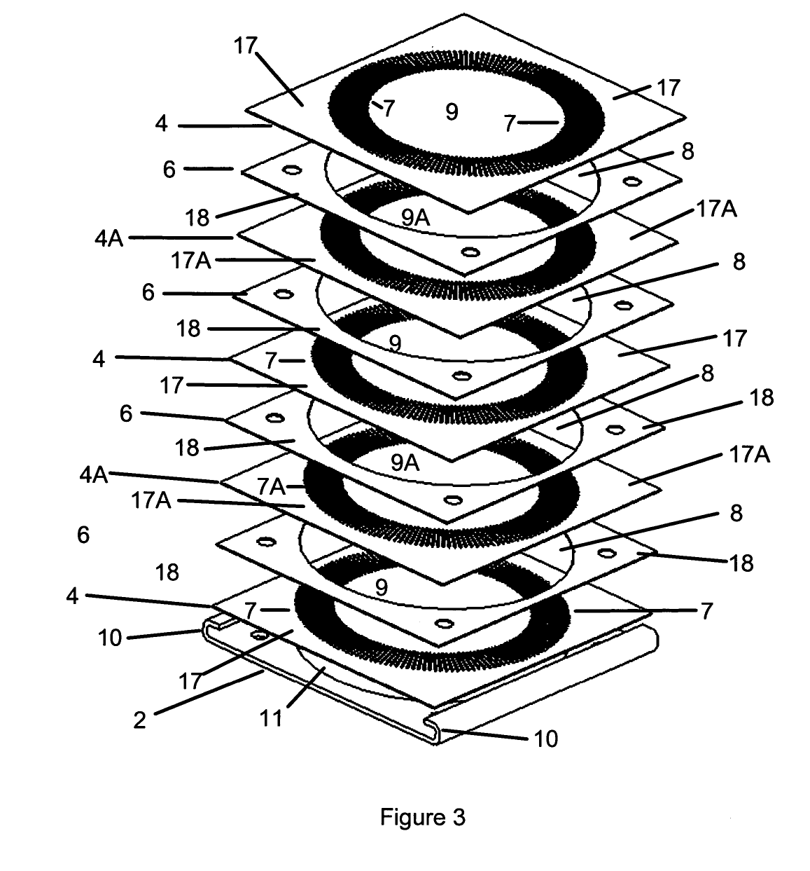

An embodiment of the microimpactor system of the invention is illustrated in FIGS. 1, 2 and 3. In FIGS. 1 and 3, microimpactor system 1 includes holder 14 and sheet stack 3 that includes a plurality of microimpactor sheets 4 and 4A and spacer sheets 6. Holder 14 includes base portion 2 having edge flanges 10. Edge flanges 10 are bent or crimped over lateral edges of sheets 4, 4A and 6 and hold them in a fixed alignment. Holder 2 includes fluid opening 11, which functions as a fluid inlet or fluid outlet port, depending on direction of fluid flow through the device. In the embodiment shown in FIGS. 1-3, the preferred direction of flow is from top-to-bottom.

In the embodiment shown in FIG. 1-3, microimpactor sheets 4 and 4A have a series of openings 5 which define microimpactors 12. As shown, openings 5 and microimpactors 12 are arranged to form annular, two-dimensional array 7 of microimpactors 12. Openings 5 and microimpactors 12 are oriented radially from the center of the circle defined by microimpactor array 7. In the embodiment shown, all openings 5 have the same width d and same length 1, and are spaced equidistant from each other. The resulting microimpactors 12 have a length 1, and a width that increases somewhat from the inside (toward the center) to the outside. If desired, all microimpactors 12 can have a constant width, with the width of openings 5 increasing from inside to outside. Microimpactor sheets 4 and 4A include center portions 9 and 9A, respectively, which block fluid flow through the center of the sheets and direct it through openings 5.

Microimpactor sheets 4 and 4A are arranged alternately, and are separated from adjacent microimpactor sheets by spacer sheets 6. In the embodiment shown, sheets 4 and 4A differ in the orientation of microimpactors 12. Microimpactors on sheet 4A are offset relative to those on sheet 4, i.e. rotated in the plane of sheet 4A so that, from a top-down perspective, microimpactors on sheet 4A are not aligned with those on sheet 4. Therefore, microimpactors on microimpactor sheets 4 and 4A define a tortuous path of fluid flow through microimpactor system 1. Fluid (and particles borne by the fluid) passing through microimpactor system 1 enters through openings 5 in the top-most microimpactor sheet 4. In order to pass through the next microimpactor sheet 4A, with its offset openings 5 and microimpactors 12, the fluid and particles must undergo a directional change, transverse to the main direction of fluid flow. Subsequent directional changes are required to negotiate through the openings 5 of each subsequent microimpactor sheet 4 or 4A. Fluid molecules have a lower molecular mass than the dispersed particles, and therefore can negotiate the changes in direction and flow through the microimpactor system and out through opening 11. Larger particles have too much inertia to make the required changes in direction, and collide with microimpactors 12, where they are removed from the fluid.

In the embodiment shown in FIGS. 1-3, peripheral regions 17, 17A and 18 of sheets 4, 4A and 6 define the outer boundary of the conduit through which the fluid/particle mixture flows, when the sheets are stacked and held together as shown in FIG. 1. Central portions 9 of microimpactor sheets 4 and 4A (and corresponding central portions of spacer sheets 6, if present) define the inner boundary of the fluid conduit through the assembled microimpactor system.

Microimpactors in adjacent sheets may be aligned with each other (i.e. form a straight line in the main direction of fluid flow), but it is generally preferred that microimpactors in adjacent rows are offset from each other as shown in FIGS. 1-3. The amount of offset can be varied, and is thus a design parameter which can be optimized for specific systems.

Spacer sheets 6 define the distance between adjacent microimpactor sheets. As shown, spacer sheets 6 have circular openings 8 that are as large as the combined areas of microimpactor array 7 and central portion 9 of microimpactor sheet 4 and the combined areas of microimpactor array 7A and central portion 9A of microimpactor sheet 4A. It is often preferred that openings 8 are coextensive only with the microimpactor arrays of the microimpactor sheets, in order to prevent unwanted fluid and particle flow between adjacent microimpactor sheets. Thus, the embodiment shown in FIGS. 1-3 may be modified by including within spacer sheets 6 a central portion that corresponds to central portions 9 and 9A of microimpactor sheets 4 and 4A.

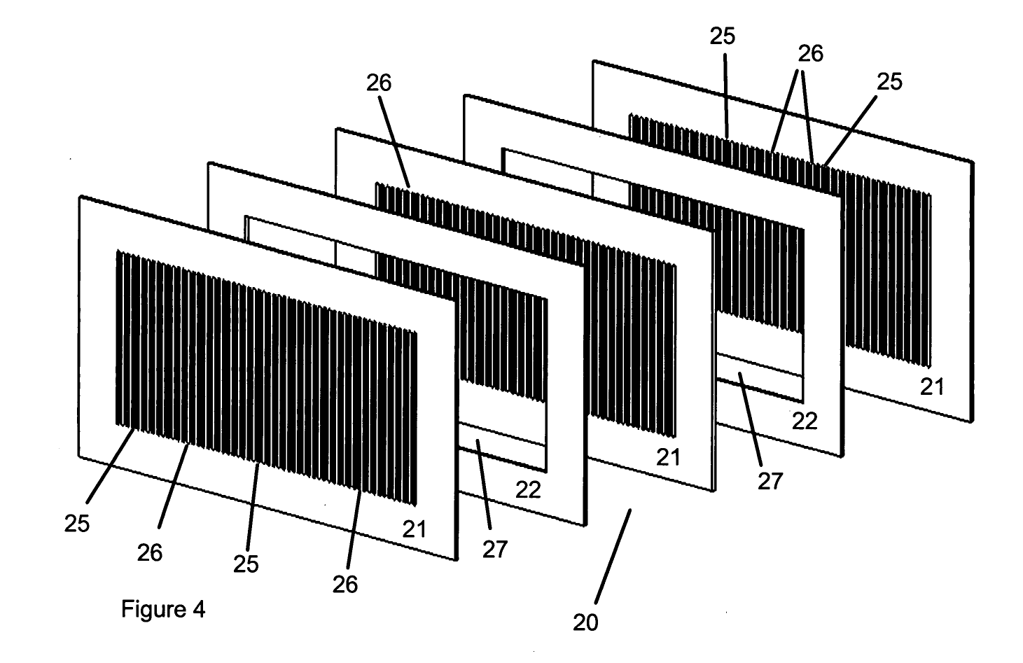

FIG. 4 illustrates an alternate microimpactor system 20, where the microimpactors form a rectangular array. In FIG. 4, microimpactor sheets 21 are arranged alternately with spacer sheets 22. Microimpactor sheets 21 have vertical openings 25 that define microimpactors 26. Microimpactors 26 on successive microimpactor sheets may be aligned or offset, depending on desired fluid flow and particle capture characteristics. Spacer sheets 22 have openings 27 that are coextensive with the microimpactor arrays of microimpactor sheets 21. The thickness of spacer sheets 22 in this embodiment determines the sheet-to-sheet spacing of the microimpactors of microimpactor sheets 21. Sheets 21 and 22 may be clamped together as in FIGS. 1-3, or may be arranged in a suitable frame or other holding device that maintains the sheets in the desired relative positions.

The ability to separate particles from a fluid will be determined by several factors, including the size of the particles, the viscosity of the fluid, the rate of flow of the fluid, the dimensions and alignment of the microimpactors, as well as other factors. Microimpactor width, microimpactor spacing transverse to the direction of flow, microimpactor spacing in the direction of flow (i.e., between adjacent microimpactor sheets 4 and 4A in FIGS. 1-3), and microimpactor alignment between adjacent sheets all impact the performance of the array. These parameters can be manipulated to provide an optimized design for any particular combination of fluid and particles. These parameters can also be optimized to allow particles to be sorted according to mass and/or size, by selecting a combination of parameters that will only capture particles of a certain size or mass, while allowing other particles to pass through. These parameters may be manipulated to minimize pressure drop or provide other operational benefits as well.

The microimpactors are in general from about 1 to about 4,000 microns wide, preferably from about 10 to 400 microns wide, especially from about 10 to about 150 microns wide, more preferably from about 10 to about 100 microns wide. The spacing between adjacent microimpactors in an individual sheet, as defined by the intervening opening, is generally about 0.1 to about 20 times the microimpactor width, preferably from about 1 to about 10 times the microimpactor width and even more preferably from about 3 to about 8 times the microimpactor width. In absolute terms, the spacing between microimpactors on an individual microimpactor sheet is generally from about 1 to about 8,000 microns, preferably from about 10 to about 800 microns, especially from about 15 to about 250 microns, and more preferably from about 100 to about 100 microns.

It is not necessary that the width of all microimpactors (either within a single sheet or within the array) be uniform, or that the spacing between them be uniform.

The height of the microimpactors is generally not critical, and will typically be chosen to provide the desired cross-sectional area to the fluid conduit. Suitable microimpactor heights can range from about 1 micron to about 50 millimeters or more, and preferably from about 500 microns to about 15 millimeters and more preferably from about 1 to 10 millimeters. Microimpactor sheets can be stacked within a fluid conduit if desired, to provide greater overall height and thus increase cross-sectional area.

Microimpactor sheet thickness will in most cases determine microimpactor thickness. Microimpactor thickness affects fluid flow patterns within the fluid conduit and therefore is a variable that affects the performance of the microimpactor system. For this reason, sheet thickness is a parameter that, like microimpactor width and spacing, can be optimized for particular applications and/or operating conditions. The sheet thickness is generally in the range of about 0.1 to about 10 times, especially from about 1 to about 3 times the width of the microimpactors. In absolute terms, the sheet thickness is suitably in a range from about 0.1 to about 10,000 microns, preferably from about 5 to about 1000 microns, especially from about 20 to about 250 microns. Identical sheets can be stacked with microimpactors aligned to form microimpactors with thicknesses that are multiples of individual sheet thicknesses.

Multiple sheets are provided within the fluid channel to provide multiple rows of microimpactors. At least two such rows of microimpactors are provided, but any greater number of rows may be used, consistent with the particular application and the pressure drop that can be tolerated. For example, the microimpactor array may contain from about 2, preferably from about 3, more preferably from about 5, even more preferably from about 10, up to 1000, preferably up to about 100, especially up to about 25, even more preferably up to about 10 rows of microimpactors.

As with other dimensions, the spacing between rows of microimpactors can be varied with the application and operating conditions to optimize the performance of the microimpactor system. This is conveniently fixed through the selection of the thickness of spacer sheets such as spacer sheets 6 in FIGS. 1-3 and spacer sheets 22 in FIG. 4. Row-to-row spacing can be increased by using multiple spacer sheets 6 between successive microimpactor sheets. However, one can instead obtain the desired spacing by using holders of various types to hold the microimpactor sheets at the desired spacing. Spacing between rows of microimpactors is suitably from about 0.5 to about 20 times, preferably from about 1 to about 10 times, especially about 3 to about 8 times, the width of the microimpactors. In absolute terms, row spacings of from about 1-15,000 microns, preferably from about 5-1600 microns, especially from about 10-300 microns, are suitable. Spacings are determined from the center of one sheet to the center of the adjacent sheet. Row-to-row spacings need not be uniform throughout the array.

The sheets are positioned in the fluid conduit so the microimpactors are oriented transversely to the main direction of fluid flow through the conduit. The particular choice of apparatus for holding the microimpactor sheets in position is not considered critical. Attachment means such as clamps screws, rivets, welds, clips, adhesives and magnets are all suitable, as are many others. In addition to the simple holder illustrated in FIG. 1, a frame may be used to both define the fluid conduit and hold the individual sheets in their desired positions. For example, microimpactor sheets of the type illustrated in FIG. 4 can be held within a frame having a rectangular cross-section. The microimpactor sheets, and spacer sheets if used, can be affixed within the frame by, e.g., slots that receive the sheets and hold them so the microimpactors are oriented transverse to the direction of fluid flow. Individual microimpactor sheets in this embodiment can be removed or replaced easily by removing them from their respective slots.

The sheets may be permanently fixed in position within the apparatus, or may be removable and/or replaceable. Microimpactor sheets may be fabricated with handles or grips which allow for easy removal and replacement.

Alternatively, the microimpactor sheets may be assembled onto a frame that is inserted within the fluid conduit. Such a frame may be removable from the fluid conduit so that the microimpactors can be easily removed for adjustment, replacement, and/or cleaning.

Although the invention is illustrated with the microimpactors arranged in flat sheets, this is not critical, and the microimpactor sheets may assume a number of nonlinear configurations, including forming curved or even circular or elliptical shapes. An embodiment of particular interest includes multiple micropillar sheets that form a series of concentric circles, polygons, ellipses or other shapes. The direction of fluid flow in such an embodiment is either from the center of the concentric sheets radially outward, or from the periphery of the concentric sheets radially inward.

The microimpactors can be made from a wide variety of materials, the choice of which may depend on the particular application in which they will be used. For example, the microimpactors may be made of a metal, a ceramic material, glass, thermoplastic or thermoset polymer, a rubber (synthetic or natural), a semiconductor material, or a combination of these materials. Different microimpactors in the array may be made of different materials. This may be desirable if, in the particular application, two or more different types of particles are to be removed from the fluid stream. The microimpactors may be substantially solid or may contain pores. Pores may be from the nano-scale up to 1 micron or more, of course depending somewhat on the dimensions of the microimpactor as a whole and the desired application.

Specific microimpactor sheet materials of construction will of course be selected for specific applications. If the microimpactors are to be charged, the material of construction is conveniently a metal or other conductive material. In cases where the microimpactors are to be heated (such as to lyse or deactivate captured biological particles), the microimpactor sheet is conveniently made from an electrical resistor that converts electrical energy to heat. The microimpactor sheet may be made from a semiconductor such as silicon, and the semiconductor may include printed electrical circuitry that allows voltages to be applied to the microimpactors (for example, to apply a charge or generate heat), or electrical signals to be transmitted from the microimpactors for monitoring or analysis. The microimpactor sheet may be a laminate or layered material.

In many applications, the microimpactors will function simply as a physical barrier to the movement of the particles through the microimpactor array, and as such the particular material of construction may not be especially important. However, there are many applications in which it is desirable that the microimpactors interact with the particles in some manner beyond presenting a simply physical barrier. In those instances, the composition of the microimpactors, or at least that of the surfaces of the microimpactors, are desirably prepared from a substance that will interact with the particles in the desired manner. To this end, the surfaces of the microimpactors may be treated or coated in various ways to promote the desired type of interaction between particle and microimpactor surface. Coatings such as this are preferably very thin, in the order of about 1 angstrom to 100 nm in thickness, so as not to significantly change the microimpactor dimensions.

Examples of interactions of this type include enhanced adhesion, decreased adhesion (for example, to facilitate cleaning), electrostatic attraction and/or repulsion, adsorption, deactivation, oxidation and/or reduction, lysing, catalysis, identification reactions, polymerization, other chemical reactions, analysis, and the like.

For example, the microimpactors may be coated with an adhesive so that the particles adhere better to the microimpactors and are more efficiently removed from the fluid stream. A wide range of adhesives is suitable. A particularly suitable type of adhesive is one that will release the particles when desired, such as by wetting, so the particles can be recovered and/or the microimpactor system cleaned. A particular adhesive that loses tack when wet is available from the Washington Technology Center, Seattle, Wash., under the trade name Tetraglyme™.

Alternatively, the microimpactors may be made from or coated with a non-stick material, such as a fluorinated polymer like Teflon™ fluoropolymer or Paralene™ polymer material (available from EM Corporation, Peachtree, Ga.) to enhance removal and/or recovery of the particles.

The microimpactors can be charged in order to electrostatically attract and bind the particles, and/or to deactivate or decompose the particles. In such a case, the microimpactors are advantageously made of, doped with or coated with a conductive or semiconductive material, which is in electrical connection to an electrical power source that supplies the necessary charge. An electrostatic attraction to the particles can be increased by applying an electrostatic charge to the particles themselves, at some point prior to passing the particle-laden stream through the microimpactor array. In such an embodiment, the particle-laden fluid is caused to flow through such a spray zone, and then into the microimpactor system, which is directly or indirectly in fluid communication with the spray zone. The spray zone includes a conduit for the particle-laden fluid and an apparatus for forming electrostatically charged droplets and spraying them into the fluid stream where they contact the particles. Atomizers of various types are known and are suitable. Examples of such sprayers include those described in U.S. Pat. Nos. 4,255,777, 4,439,980, 4,784,323, 5,062,573, 5,378,957, 6,227,465, 6,318,648 and WO 01/21319A1, all incorporated herein by reference. A particular preferred type of atomizer is described in US Published patent application 2003/0071134A1, incorporated herein by reference. That atomizer includes (A) at least one microinjector including (1) an orifice through which the liquid is brought in contact with a pin emitter and (2) a conductive pin emitter extending outwardly from said orifice, the pin emitter having a radius of curvature in at least one location external to said orifice of no greater than 500 μm; B) means for introducing the liquid to be atomized through the orifice and to the pin emitter, and C) means for connecting said pin emitter to a voltage source. The liquid is preferably under a hydrodynamic pressure of 5 in H₂O or less.

Other materials of construction or coatings for the microimpactors include various types of materials that decompose and/or deactivate the particles, catalyze their decomposition and/or deactivation, catalyze some other reaction of the particles with themselves or other materials (including the microimpactors themselves), or else react directly with the particles. A wide range of such materials is possible, depending on the specific application. Deactivation and/or decomposition are particularly desirable in the case where the particles are pathogenic and/or toxic. In that case, the microimpactor surface can include, for example, a strong oxidant or reducing agent, or a toxin for the particles (in the case of a biological material). An example of such a deactivating agent is a platinum-on-alumina catalyst, which has been developed as an air purification catalyst for use against nerve agents. If the fluid sample is thought to contain multiple types of pathogenic and/or toxic agents, different microimpactors can be treated with different coatings, or made of different materials, each of which will deactivate and/or decompose a specific type of suspected pathogenic or toxic agent. Alternatively, different portions of individual microimpactors can be made of different materials for the same purpose.

Yet other materials of construction or coatings for the microimpactors include antibodies, ligands and membrane materials, which can perform, for example, enhanced particle capture, identification, inactivation, catalytic and/or reagent functions.

The microimpactor may be made of or include a piezoelectric material, if desired, so that controlled movement and/or physical distortion of the microimpactors can be caused through the application of an electrical current.

The microimpactor sheets can be made in a variety of manufacturing process, which may depend somewhat on the material(s) of construction. Micromachining, photo-chemical etching, embossing, lithographic galvanic anodization (LIGA), lamination, injection molding, deep reactive ion etching (DRIE) and other fabrication methods can all be used. Of particular interest are photo-chemical etching and DRIE methods, as these can allow for rapid, inexpensive manufacture of microimpactor sheets with very good precision.

Microimpactor sheets may be connected to electrical circuitry through various types of edge connector devices. Electrical circuitry includes, for example, connections to sources of electrical power and various kinds of detection and/or analytical devices.

Spacer sheets can be made of the same kinds of materials as the microimpactor sheets. However, spacer sheets are generally not used to capture particles, and typically will not have highly specialized functions. It is therefore preferred to select spacer sheets materials of construction based on cost and ease of fabrication. Within any particular microimpactor systems, spacer sheets may or may not be of the same materials of construction as the microimpactor sheets, and it is not necessary for all spacer sheets to be made of the same material. If any of the microimpactor sheets are to be charged, the adjacent spacer sheets may be made of a nonconductive material that prevents the charge from being conducted to other microimpactor sheets.

Particles are removed from a fluid stream by flowing a particle-laden fluid through the fluid conduit in a main direction of flow transverse to the orientation of the microimpactors. The rows of microimpactors define a tortuous flow path through the fluid conduit, forcing the fluid (and particles) to change direction multiple times as it flows through the conduit. The particles have greater inertia than the fluid, due to their high mass (relative to that of the fluid molecules), and therefore tend to negotiate the changes in direction more poorly than the fluid. This causes the particles to impact and adhere to the microimpactors. In this manner, particles are removed from the fluid as it flows through the fluid conduit.

Captured particles often form extended “dentrite” structures by accumulating on the microimpactors in the form of “strings” of captured particles. This effect is often enhanced when an electrostatic charge is applied to the microimpactors (and optionally the particles to be captured). These dentrites extend from the surface of the microimpactors and often have the effect of increasing the ability of the microimpactors to capture more particles, thereby increasing the overall efficiency, with little or no corresponding increase in pressure drop.

Fluid flow through the microimpactor system may be provided by applying fluid pressure upstream of the system, by drawing a vacuum downstream of the system, or by ion wind generation (which may be effected by applying a charge to the microimpactor system). A variety of fans, micropumps and other devices may be used either upstream or downsteam of the microimpactor system to effect the flow. These may be incorporated in fluid communication with the microimpactor system in a single device. For certain applications, such as personal protection devices, the requisite fluid flow can be produced through the inhalation or exhalation of an individual using the device. The microimpactor system can generally operate under relatively low pressure drops, such as <500 Pascals and especially less than about 100 Pascals, such as from about 10 to about 100 Pascals.

Fluid flow through the microimpactor system may also be achieved through movement of the microimpactor relative to the fluid, such as, for example by rotating the microimpactor system to obtain centrifugal movement of the fluid, or by moving the microimpactor system laterally through a fluid.

The microimpactor array can be designed to operate at a wide variety of flow rates, depending on application. However, because of the low pressure drop afforded by the microimpactor array, it is particularly of interest in applications involving low to moderate pressures.

The efficiency of the particle removal, and the size and the size of the particles that are collected, are functions of various factors, including flow rates, microimpactor widths and spacing, spacing between rows of microimpactors, the mass of the particles, the mass of the fluid molecules, and the viscosity of the fluid (which may be negligible when the fluid is a gas, as is preferred), the surface properties of the microimpactors, the presence or absence of electrostatic charges, and other factors.

Because the geometry of the microimpactor system plays a significant role in how well it operates in any particular application, the ability to tailor the geometry by varying parameters such as microimpactor size and spacing provides a significant versatility that is absent from earlier micromachined micropillar arrays. In experimental settings, for example, the microimpactor system of the invention is excellent for verifying the accuracy of computational models of fluid flow and particle capture. By replacing, adding and/or removing various individual microimpactor sheets from an array, the various geometrical parameters such as microimpactor width, spacing and row-to-row spacing can be varied easily to conform to specific computational models. This allows for much more rapid testing and evaluation. In other applications, the ability to replace, add or remove individual microimpactor sheets provides the possibility of adapting the microimpactor system to work in multiple applications, thereby greatly improving its versatility. This can be especially important in various integrated devices as described below, in which the microimpactor system forms part of a more complex device.

In this invention, a “fluid” is considered to be any material capable of fluid flow, including gasses, liquids, molten materials, and the like. The invention is particularly useful for removing particles from gasses, including air, nitrogen, oxygen, argon, helium, hydrogen, hydrocarbons, carbon dioxide, chlorocarbons, fluorocarbons, chlorofluorocarbons, various mixtures of gasses and the like.

“Particles”, in the context of this invention, include both solid particulate matter, as well as liquids that exist as discrete droplets within the fluid stream. To be separable, the particles need to have mass that is significantly greater than that of the molecules of the carrier fluid. The greater inertia of the particles causes them to change direction more slowly than the molecules of the carrier fluid. Particles having a longest dimension of from about 0.01-100 microns, especially from about 0.1 to about 100 microns, are particularly suitable for removal from a gaseous carrier fluid using this invention.

The composition of the particles is generally unimportant to the operation of the invention. The particles may include various types of biological matter such as bacterial spores, viruses, other microorganisms and pollen, and may include pathological agents such as anthrax or smallpox spores. The particles may include other chemical aerosols of all types, including those which have toxological properties. The particles may include inorganic or other organic particulate matter or droplets, such as water droplets, smog particles, smoke particles, dust particles, mineral particles, metal particles, and the like.

Captured particles and absorbed may be removed from the microimpactor array using various methods, such as the application of heat (to degrade, volatilize or combust the particles), by backwashing with a fluid flow in the reverse direction, flushing with solvents, removal or reversal of an applied electrostatic charge, various mechanical methods such as brushing, wiping, washing and the like, as well as other methods. Removed particles can be disposed of, taken for analysis, or used for various purposes as desired.

The microimpactor system of the invention can be used as a stand-alone device or combined with various other components to form an assembly that is adapted for specific applications. Examples of specific applications and devices that incorporate the microimpactor sytem are described below. Other uses for the microimpactor system are described, for example in U.S. Pat. No. 6,110,247, incorporated hereinb by reference.

A. Simple particle filtration. In these applications, the microimpactor system operates simply to capture particles to remove them from the fluid, primarily for cleaning purposes. The captured particles may be removed from the microimpactor system if desired, so that the microimpactor system can be re-used. Alternatively, the used microimpactor system (or individual microimpactor sheets) may be disposed of along with the captured particles and replaced as needed. The microimpactor system can be incorporated into various devices to be used in filtration applications. The devices can include, for example, means as described before, in fluid communication with the microimpactor system, for creating a flow of the fluid through the microimpactor system; means for applying an electrostatic charge to the microimpactor system or some portion thereof; means for applying an electrostatic charge to the particles; an optional prefilter or postfilter in fluid communication with the microimpactor system for removing larger or smaller particles that are not captured by the microimpactor system, an optional means to pre-sort incoming particles by size or to remove the bulk of the particles; a fluid inlet and fluid outlet to the device, and optionally means for accessing the microimpactor device for replacement, maintenance and/or cleaning. Such accessing means include, for example, various types of openings, which may be reclosable, through which the microimpactor device can be removed from the device and/or manipulated, cleaned or repaired.

Similarly, the microimpactor system can used as a pre- and/or postfilter in a device that includes at least one other filtration device, such as a screen, a virtual impactor, or an inertial separator. In pre-filtration applications, the microimpactor can remove particles of a pre-determined size that may be too small or two large to be captured efficiently by the main filtration device. A device in which the microimpactor system functions as a pre- or postfilter includes, in fluid communication, a fluid inlet, a main filtration device, a fluid outlet, at least one microimpactor system located upstream (in the case of a prefilter) and/or downstream (in the case of a postfilter) of the main filtration device and optionally at least one means for creating a flow of the fluid through the device. The device may contain means to electrostatically charge the microimpactors and/or the particles.

In post-filtration applications, the microimpactor can be used to capture particles that are not collected by the main filtration device, or as a sensor or a component of a sensor that indicates the condition and/or remaining useful life of the main filter. As the main filter ages or becomes laden with captured particles, its openings can become almost entirely blocked. This causes the pressure drop across the filter to increase and the volume of particles passing through the filter to decrease. Conversely, aging or dirty filters often develop defects that allow particulate matter to pass through that would otherwise be captured. The rate at which particles are captured by the post-filter is therefore indicative of the condition of the main filter. This rate may be determined visually by simply inspecting the microimpactor post-filter system, by removing the microimpactor system for remote analysis, or by conducting an in situ analysis of collected particles.

B. Particle recovery. Captured particles can be recovered for analysis or use using a variety of particle recovery techniques such as described above. Devices adapted for such applications are typically similar in design to those used for filtration applications, and include in fluid communication, a fluid inlet, a main filtration device, a fluid outlet, at least one microimpactor system and optionally at least one means for creating a flow of the fluid through the device. The device may contain means for electrostatically charging the particles and/or the microimpactors. Devices for particle recovery applications preferably include means for accessing the microimpactor device for analysis, replacement, maintenance and/or cleaning, as described before.

C. Particle classification. In these applications, the microimpactor system is used, in conjunction with other microimpactor systems, or in conjunction with other particle separation devices, to sort particles by, for example, size, weight, shape, composition or other characteristics. In the simplest application, a single microimpactor system (or two or more like microimpactor systems) removes particles having one or more predetermined characteristics from a fluid stream, while allowing particles that do not have such characteristic(s) to pass.

Multiple microimpactor systems can be used in series or parallel to classify and capture particles having different characteristics. In such cases, two or more of the microimpactor systems will differ from each other in some manner that allows each of them to selectively remove particles having different characteristics from the fluid stream. For example, a particle classification device may contain a first microimpactor system that captures particles of a first size range, and a second microimpactor system that captures particles of a smaller or larger size range. The two microimpactor systems are preferably arranged in series and in fluid communication with each other, with the device having a fluid inlet upstream of the microimpactor systems and a fluid outlet downstream of the microimpactor systems.

Alternatively, a particle classification device may contain a first microimpactor system that is electrostatically charged, and thus captures electrostatically charged particles. The device will include means for applying an electrostatic charge to the microimpactors. Such a device optionally includes means for introducing an electrostatic charge onto the particles, preferably located upstream of the microimpactor system. Suitable devices for introducing an electrostatic charge are described in various references mentioned above.

A particle classification device can alternately include a microimpactor system that has surface characteristics that enable it to preferentially capture particles that chemically interact with the microimpactor surface. A second microimpactor system is then provided to capture other particles that are not collected by the first microimpactor system. The second microimpactor system will typically include a different geometrical arrangement of the microimpactors.

In other embodiments, the microimpactor system is used in combination with other particle separation and/or capture devices to sort particles according to predetermined characteristics. Examples of such other separation and/or capture devices include virtual impaction particle collectors, acoustic concentrator devices, and other types of particle collection and separation devices as described before. These devices may be used upstream of the microimpactor device to sort out particles that, for example, are larger or smaller than those of interest, and to concentrate the particles for capture on the microimpactor system.

D. Particle Analysis and/or Detection. In these applications, captured particles are subject to one or more analytical techniques to determine physical, chemical and/or biological attributes, or to indicate the presence of certain types of particles. Post-capture particle analysis or detection can be performed after removing the collected particles from the microimpactor system, or on the particle-laden microimpactor system. In the latter case, particle analysis or detection can be done performed in-line and continuously, if desired.

The particular analytical or detection technique to be used will of course depend on the particles and the nature of the evaluation. Collected particles may be removed from the microimpactor system if desired or necessary using techniques as set forth above.

For in-line particle analysis and detection, the microimpactor system and collected particles may be interrogated using a variety of sensing techniques, including visible and/or UV fluorescence, tetrahertz spectroscopy, Raman spectroscopy, IR spectroscopy, mass spectroscopy, MALDI-MS and the like. In these applications, it is preferred that the microimpactors are transparent to the particular sensing device, or else distinguishable from the captured particles by that particular sensing device. The microimpactor may instead be made from or coated with various types of reagents, probes or biological materials such as ligands or antibodies, which engage in a chemical reaction or bond to specific types of particles and thereby indicate the presence of those particles in the fluid.

Thus, a particle analyzer according to an aspect of the invention includes one or more microimpactor systems, a fluid inlet and fluid outlet to the device in fluid communication with the microimpactor system, and at least one analytical device adapted to interrogate the microimpactor system for detection and/or analysis of captured particles. Such a particle analyzer may contain various optional but preferred features as have been described before with respect to other applications, including, for example, circuitry for powering and operating the analytical device and for obtaining data from the analytical device and converting it to human-readable form; various types of readouts and displays; means for creating a flow of the fluid through the microimpactor system; an optional prefilter or postfilter in fluid communication with the microimpactor system for removing larger or smaller particles that are not captured by the microimpactor system, an optional means to pre-sort incoming particles by size or to remove the bulk of the particles; and optionally means for accessing the microimpactor device for replacement, maintenance and/or cleaning. If desired, the entire particle analyzer can be mounted onto an integrated circuit board or other device, in order to integrate particle collection and detection/analysis. The analytical device can be of various types as described in the preceding paragraph.

A particle detection device according to the invention is of similar design, except that instead of or in addition to the analytical device, reagents, probes or biological materials such as ligands or antibodies are present on the surface of the microimpactors to indicate the presence of specific types of particles in the fluid.

In another type of detector device, microimpactors are made from an optically transparent material such as quartz that is coated with a nuclear detection material (such as copper or nanoporous copper) that generates photons when it detects a particular material of interest. The microimpactor is connected to a fiber optic material that transmits the generated photon to a collector. The circuitry may include a filter, that allows only photons of a desired wavelength to pass (to remove noise or signals from species that are not of interest) and a photomultiplier to increase the signal.

E. Particle lysing, deactivation, catalysis and chemical reactions. Particles captured by the microimpactor system can be subjected to a wide variety of operations, examples of which are lysing, deactivation, catalysis, and various chemical reactions such as oxidation or polymerization. This can be accomplished in several ways. Captured particles may of course be recovered from the microimpactor system and treated. The microimpactors themselves may be made from, be coated with or otherwise contain an agent that reacts with the captured particle to accomplish the desired operation. Alternatively, the particle-laden microimpactors may be exposed to an agent which accomplishes that operation. The microimpactors may also conduct electrical or thermal energy to the captured particles for performing lysing, other electrochemical reactions or thermal degradation of captured particles.

A specific example of the foregoing is the deactivation of toxic chemical and biological agents and pathogens. In many military and civilian applications, it is necessary to protect individuals from ambient air-borne toxic materials and pathogens. Such toxic materials may include nerve agents, perfluorocarbons, other gaseous toxins, pathogenic microorganisms such as anthrax, smallpox or viruses, and the like. In such applications, a personal protection apparatus such as a breathing apparatus includes a microimpactor system in which the microimpactors are made from or coated with materials that react with, bind or otherwise deactivate specific types of air-borne toxins and pathogens. Thus, the microimpactor system serves not only to capture toxic and pathogenic particles, but also to render them into a non-hazardous or less hazardous form. A wide variety of deactivating materials can be used to make or coat the microimpactors, as described above. Combinations of different deactivating materials can be used to provide protection from mixtures of toxic agents and/or pathogens. For example, some microimpactors may be coated with a deactivating agent for one specific toxin or pathogen, whereas other are coated with a different deactivating agent for some other toxin or pathogen.

Alternatively or in addition, the microimpactors may be connected with a source of electrical energy, which allows the microimpactors to become electrostatically charged and lyse or inactive the toxic or pathogenic agent. The microimpactors may be combined with an energy source that heats the microimpactors and thermally lyses or inactives the toxin or pathogen. The high surface area of the microimpactors allows excellent heat exchange with the captured particles and the fluid, allowing for very efficient thermal lysing and deactivation reactions to occur.

In another alternative, the microimpactor surface is made from or is coated with a catalyst that catalyzes a lysing or deactivation reaction between a toxin or pathogenic agent and some other reagent. The other reagent can be supplied together with or separately from the particle-laden fluid to perform the lysing or deactivation reaction on the captured particles.

A breathing device containing the microimpactor system as described can replace or supplement conventional gas mask technology. It is also scalable to collective protection applications such as shelters.

F. Non-particle capture applications. The microimpactor system is used in a variety of applications where a high surface area absorbent, reactive or catalytic surface is desired. The microimpactor system is particularly useful in low volume and/or in low pressure drop applications. Specific examples of such applications include:

1. Absorption. A microimpactor system having an absorbent surface effectively removes specific gasses from the fluid, through chemical affinity, electrostatic attraction or other attractive forces. As before, the microimpactors can be interrogated using various tools to detect the presence of such captured gasses, making the microimpactor system useful as a device for detecting the presence of those gasses in a fluid stream. If desired, the microimpactors may be in addition electrostatically charged and/or heated as described before to destroy or inactivate the specific gas. Further, the microimpactor containing the captured gas can be exposed to various types of chemical reagents that react with the captured gas to form a desired reaction product.

2. Catalytic oxidation. Personal protection devices for military and other applications often require that toxic gases be removed so air can be safely breathed. Certain nitrogen-containing toxic gases and agents are effectively destroyed by passing a mixture of them in an oxygen-containing atmosphere through a microimpactor system, in which the microimpactors are coated with a substance which catalyzes the thermal destruction of such compounds. A suitable such catalytic material is a platinum or palladium catalyst, which may be supported on a suitable support such as alumina. For a breathing apparatus that removes nitrogen-containing toxins and agents, catalysts that do not form NOₓ compounds are preferred. The microimpactor system is provided with a means to heat the microimpactors and/or the fluid conduit containing the microimpactors to a temperature at which the thermal decomposition of the toxic agent takes place. This can be accomplished, for example, by applying heat from an external flame (as would be suitable for use with small, lightweight personal protection apparatus useful in military applications, for example). Alternatively, the microimpactors may be made from an electrical resistor which generates heat when an electrical current is supplied.

Perfluorinated compounds can be catalytically destroyed in like manner, using a microimpactor system in which the microimpactors are coated with a suitable catalyst for the oxidation of such compounds.

Mixtures of toxic gases and agents can be effectively deactivated or destroyed in accordance with this invention. In one approach, this is accomplished by flowing a fluid containing the toxins through multiple microimpcator systems, arranged in series, in which each microimpactor system contains a catalytic coating that is specific for one of the toxins in the fluid. Alternatively, a single microimpactor system can be used, in which individual microimpactors within the microimpactor system are coated with the different catalysts.

3. Heat exchange. The high surface area of the microimpactor device makes it very useful as a device for removing heat from or transferring heat to a fluid. In this application, the microimpactors can be made of a thermally conductive material that allows them to efficiently transport heat away from or to the fluid. The microimpactors may be in thermal connection with an outside source of heat or cooling to augment its heat exchange function. In certain embodiments, the microimpactors are made of a resistor material, which converts an applied electrical voltage into heat for warming a fluid.

It will be appreciated that many modifications can be made to the invention as described herein without departing from the spirit thereof, the scope of which is defined by the appended claims.

1. A microimpactor system comprising a fluid conduit having a plurality of spaced-apart rows of microimpactors arranged in the fluid conduit substantially transverse to a main direction of flow of fluid through the fluid conduit, wherein each of said rows of microimpactors is formed by a microimpactor sheet having a plurality of openings that define in each such sheet at least one line of two or more microimpactors.

2. The microimpactor system of claim 1, wherein microimpactors in at least two successive rows are offset from each other.

3. The microimpactor system of claim 1, wherein microimpactors in successive rows are spaced apart at a distance defined by one or more spacer sheets interposed between the successive rows of microimpactors.

4. The microimpactor system of claim 1, wherein the fluid conduit includes a fluid inlet and a fluid outlet.

5. The microimpactor system of claim 1, wherein the microimpactor system further comprises a means for moving fluid through the system.

6. The microimpactor system of claim 1, further comprising means for applying an electrical charge to at least one microimpactor sheet.

7. The microimpactor system of claim 6, further comprising means, upstream from said microimpactor sheets for applying an electrical charge to particles borne in a fluid transported through the fluid conduit.

8. The microimpactor system of claim 1, wherein at least one of said microimpactor sheets is removable and replaceable.

9. The microimpactor system of claim 1, wherein at least two of said microimpactor sheets are made of different materials.

10. A method of forming an array of microimpactor surfaces within a fluid conduit, comprising positioning two or more microimpactor sheets each having openings that define in each microimpactor sheet at least one line of two or more microimpactors, the microimpactor sheets being positioned such that said microimpactors are oriented transverse to a main direction of flow of a fluid through the fluid conduit.
